(19) United States
(12) Patent Application Publication
(10) Pub. No.: US 2021/0290460 A1
(43) Pub. Date: Sep. 23, 2021

(54) WHEELCHAIR

(71) Applicant: GUANGZHOU SHIYUAN ELECTRONICS CO., LTD., Guangzhou, Guangdong (CN)

(72) Inventor: Zhirong DAI, Guangzhou, Guangdong (CN)

(73) Assignee: GUANGZHOU SHIYUAN ELECTRONICS CO., LTD., Guangzhou, Guangdong (CN)

(21) Appl. No.: 17/261,082

(22) PCT Filed: Nov. 30, 2018
(86) PCT No.: PCT/CN2018/118576

§ 371 Date: Jan. 18, 2021

(30) Foreign Application Priority Data
Jul. 20, 2018 (CN) 201821156942.9

(51) Int. Cl. A61G 5/10; A61G 5/08; A61G 5/12; A61G 5/04

(52) U.S. Cl. CPC A61G 5/1048; A61G 5/08; A61G 5/1005; A61G 5/04; A61G 5/125; A61G 5/122; A61G 5/1045

(57) ABSTRACT

A wheelchair comprises: an armrest bracket (6), a seat bracket, a backrest bracket (3), and a turning mechanism (64), wherein the turning mechanism (64) is configured to make the armrest bracket (6) and the seat bracket rotate synchronously relative to the backrest bracket (3).

The present application claims the priority to Chinese patent Application No. 201821156942.9, with the title of “Wheelchair”, filed on Jul. 20, 2018, and the entire contents of the above-identified application are incorporated by reference.

### FIELD OF THE INVENTION

The disclosure relates to the technical field of transportation means, such as a wheelchair.

### BACKGROUND OF THE INVENTION

Wheelchairs are not only transportation means for the physically disabled and people with limited mobility, but also an important rehabilitation tool that facilitates users of wheelchairs to exercise and participate in social activities with the help of the wheelchairs.

A wheelchair generally includes a wheelchair frame, wheels, brake devices, seat cushions and back cushions, etc. Thereinto, the wheelchair frame generally includes a seat bracket, a backrest bracket, a front wheel bracket, and a rear wheel bracket, etc. The front wheels of the wheels are arranged on the front wheel bracket, and the rear wheels of the wheels are arranged on the rear wheel bracket. The brake device is arranged on the wheels, and the seat cushion and the backrest cushion are respectively arranged on the seat bracket and the backrest bracket. Common wheelchairs are operated by manual push. A hand-cranked wheelchair adds a hand-cranked device on the basis of the above-mentioned structure to control the operation of the wheelchair. An electric wheelchair adds an electrically powered assistance system on the basis of the above-mentioned structure, which can make it more convenience for users of the wheelchair to operate and control the operation of the wheelchair, reducing the physical exertion of the user.

Due to the large volume and weight of the wheelchair, in order to facilitate the use of the wheelchair, in related technologies, most electric wheelchairs have a foldable structure, but this makes the structure of most wheelchairs complicated. Therefore, it is difficult for the armrests to be folded synchronously with the seat bracket and the backrest bracket, which limits the overall effectiveness of folding effect the wheelchair.

### SUMMARY OF THE INVENTION

The disclosure provides a wheelchair, which can realize the synchronous folding of the armrest and the seat bracket with a simplified structure and a good folding effect.

A wheelchair comprises an armrest bracket, a seat bracket, a backrest bracket, and a turning mechanism, wherein the turning mechanism is configured to make the armrest bracket and the seat bracket rotate synchronously relative to the backrest bracket.

### BRIEF DESCRIPTION OF THE DRAWINGS

FIG. 1 is a schematic diagram of the structure of a wheelchair in an unfolded state according to an embodiment.

FIG. 2 is a schematic diagram of the structure of the wheelchair in a folded state according to an embodiment.

FIG. 3 is a schematic diagram of the structure of a wheelchair bracket in a perspective view according to an embodiment.

FIG. 4 is a schematic diagram of the split structure of an armrest bracket according to an embodiment.

FIG. 5 is a partial enlarged view of section I in FIG. 4.

FIG. 6 is a schematic diagram of the structure of the wheelchair bracket viewed from another perspective point according to an embodiment.

FIG. 7 is a schematic diagram of the structure of a control box viewed from a perspective point according to an embodiment.

FIG. 8 is a schematic diagram of the structure of the control box viewed from another perspective point according to an embodiment.

FIG. 9 is a schematic diagram of the split structure of the control box according to an embodiment.

FIG. 10 is a schematic diagram of the structure of a rear wheel assembly according to an embodiment.

FIG. 11 is a schematic diagram of the structure of the rear wheel assembly of which the cover cap is removed according to an embodiment.

FIG. 12 is an exploded view of FIG. 11.

FIG. 13 is a schematic diagram of the structure of a fixing plate and fixing members according to an embodiment.

FIG. 14 is a schematic diagram of the structure of a wheel hub viewed from a perspective point according to an embodiment.

FIG. 15 is a schematic diagram of the structure of the wheel hub viewed from another perspective point according to an embodiment.

FIG. 16 is a schematic diagram of the structure of a rear-wheel driving assembly according to an embodiment.

FIG. 17 is a schematic diagram of the structure of a first clamping plate according to an embodiment.

FIG. 18 is a schematic diagram of the connection structure of the rear-wheel driving assembly according to an embodiment.

FIG. 19 is a schematic diagram of the partial structure of the wheelchair bracket according to an embodiment.

FIG. 20 is a schematic diagram of the structure of a seat front rotation shaft according to an embodiment.

FIG. 21 is a schematic diagram of the structure of a pedal bracket according to an embodiment.

FIG. 22 is a schematic diagram of the structure of a master driving assembly according to an embodiment.

FIG. 23 is a schematic diagram of the structure of a buffer member according to an embodiment.

FIG. 24 is a schematic diagram of a locking mechanism switchable between a locked state and an unlocked state according to an embodiment.

FIG. 25 is a schematic diagram of the structure of the locking mechanism arranged on a wheelchair according to an embodiment.

1—Seat front bracket, 11—Front seat plate, 12—First front—seat support rod, 13—Seat connecting sleeve, 2—Seat rear bracket, 21—Rear seat plate, 22—First rear—seat support rod, 3—Backrest bracket, 31—Headrest portion, 32—Backrest portion, 33—Support portion, 331—Connecting rod, 34—Extension portion, 4—Front wheel bracket, 41—Front wheel, 42—First front-wheel support rod, 421—Connecting rod portion, 422—Hinging portion, 43—Second front-wheel support rod, 44—Front-wheel connecting frame, 45—Front wheel stopper, 46—Protection box, 47—Protection cover, 48—Front-wheel connecting sleeve, 5—Rear wheel bracket, 51—Rear wheel, 52—Wheel hub, 521—Inner wheel hub, 5211—Limit groove, 5212—Penetration hole, 5213—Mounting hole, 522—Outer wheel hub, 523—Spoke, 53—Cover cap, 54—Fixing plate, 541—Fixing hole, 542—Fixing member, 543—Locking member, 55—Rear-wheel driving assembly, 551—Driving portion, 5511—Driving sleeve, 5512—First sealing cover, 5513—Second sealing cover, 552—Transmission portion, 5521—Third sealing cover, 5522—Fourth sealing cover, 553—Braking portion, 554—First connecting ear plate, 555—Second connecting ear plate, 556—Connecting lug, 5561—Buffer member, 561—First clamping plate, 562—Second clamping plate, 563—First connecting sleeve, 564—Second connecting sleeve, 565—First connecting through hole, 566—Shaft connecting hole, 567—Second connecting through hole, 57—First rear-wheel support rod, 58—Second rear-wheel support rod, 59—Third rear-wheel support rod, 501—Stiffener plate, 502—Rear wheel baffle, 503—Bracket protection plate, 504—Rear-wheel connecting sleeve, 505—Output shaft, 6—Armrest bracket, 61—Armrest, 62—First armrest rod, 63—Second armrest rod, 64—Turning mechanism, 641—First gear, 642—Second gear, 643—Adapter plate, 6431—First plate, 6432—Second plate, 6433—Limit block, 644—Gear rotation shaft, 6441—Armrest connecting portion, 6442—Rear-seat connecting portion, 6443—Gear connecting portion, 6444—Limit flange, 645—Gear protective box, 646—Sealing cover, 7—Pedal bracket, 71—Foot pedal, 72—Pedal front bracket, 721—First front support rod, 722—Second front support rod, 73—Pedal rear bracket, 731—First rear support rod, 732—Second rear support rod, 74—Hinging shaft, 75—Hinging frame, 76—Hinging sleeve, 77—Adjusting rod, 78—Support sleeve, 8—Master driving assembly, 81—Fixing portion, 82—Telescopic portion, 91—Front seat cushion, 92—Rear seat cushion, 93—Back cushion, 101—Driving rotation shaft, 102—Seat rear rotation shaft, 104—Seat front rotation shaft, 1041—Front-wheel connecting portion, 1042—Seat connecting portion, 1043—First limiting portion, 1044—Shaft connecting portion, 1045—Rear-wheel connecting portion, 1046—Second limiting portion, 1047—Limit sleeve, 105—Pedal rear rotation shaft, 106—Pedal front rotation shaft, 107—Armrest Front rotation shaft, 108—Support shaft, 109—Front-wheel lower rotation shaft, 20—Anti-roll bracket, 201—Anti-roll wheel, 30—Battery box, 40—Control box, 401—First housing, 4011—First panel, 4012—First side plate, 4013—First bottom plate, 4014—First lug, 4015—Second lug, 402—Second housing, 4021—Second panel, 4022—Second side plate, 4023—Heat dissipation groove, 403—Cover body, 4031—Threading through hole, 404—Mounting portion, 405—Electric control assembly, 406—Mounting plate, 407—Wiring port, 408—Sealing ring, 409—Sealing strip, 601—Switch member, 602—Locking execution member.

### DESCRIPTION OF THE PREFERRED EMBODIMENTS

In the description of the present application, unless expressly stipulated and limited otherwise, the terms “connect with”, “connect to”, and “fix” shall be interpreted broadly. For example, they may be a fixed connection, a detachable connection, or an integrated configuration. They may be a mechanical connection or an electrical connection. They may be a direct connection or an indirect connection through an intermediate medium. They may be the internal communication between two components or the interaction relationship between two components. For those skilled in the art, the concrete meanings of the above-mentioned terms in the present application can be understood under particular circumstances.

In the present application, unless expressly stipulated and defined otherwise, a first feature being “on” or “under” a second feature includes that: the first and second features are in direct contact, or the first and second features are not in direct contact but are in contact through other features therebetween. Moreover, the first feature being “over”, “above” and “on” the second feature may include that the first feature is directly above and obliquely above the second feature, or may merely mean that the level height of the first feature is greater than that of the second feature. The first feature being “under”, “below” and “beneath” the second feature may include that the first feature directly below and obliquely below the second feature, or may merely means that the level height of the first feature is smaller than that of the second feature.

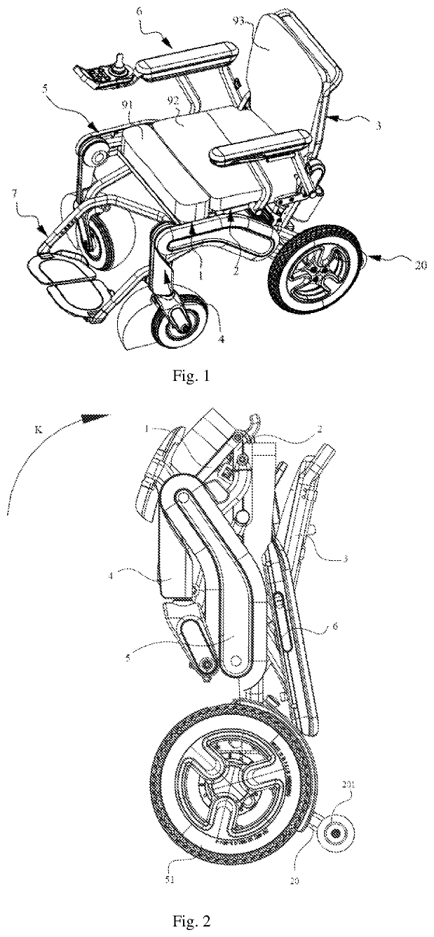

FIG. 1 is a schematic diagram of the structure of a wheelchair in an unfolded state according to an embodiment. FIG. 2 is a schematic diagram of the structure of the wheelchair in a folded state according to an embodiment. As shown in FIGS. 1 and 2, the foldable wheelchair according to this embodiment has two states: a folded state and an unfolded state. When the wheelchair is in the unfolded state, a user of the wheelchair can normally use the wheelchair as a means of transportation or rehabilitation aid. When the wheelchair is in the folded state, it is convenient for the wheelchair user or other auxiliary personnel to transport and store the wheelchair, saving the space occupied by the wheelchair.

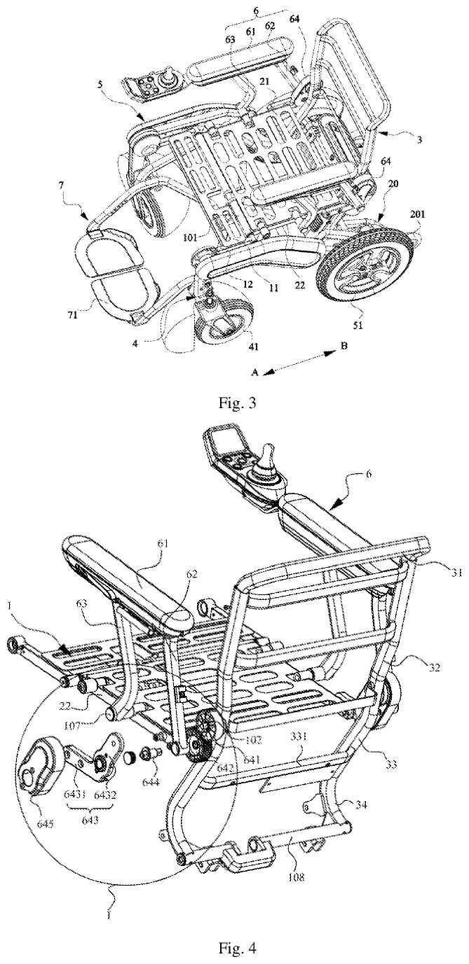

The wheelchair according to this embodiment mainly includes a wheelchair bracket, a front wheel 41, a rear wheel 51 and a master driving assembly 8. Thereinto, the wheelchair bracket includes a seat bracket, a backrest bracket 3, a front wheel bracket 4, a rear wheel bracket 5, a pedal bracket 7, an armrest bracket 6, and an anti-roll bracket 20. Thereinto, the seat bracket is partitioned into a seat front bracket 1 and a seat rear bracket 2. The seat front bracket 1 and the seat rear bracket 2 are rotationally connected by a driving rotation shaft 101. By applying a force to the driving rotation shaft 101, the seat front bracket 1 and the seat rear bracket 2 can be relatively unfolded or folded, and at the same time, the front wheel bracket 4, the rear wheel bracket 5, the pedal bracket 7 and the armrest bracket 6 are integrally driven to fold along the direction indicated by K from the unfolded state to the folded state, or return along the direction opposite to the K direction from the folded state to the unfolded state. Thereinto, the direction indicated by an arrow A in FIG. 3 is front, and the direction indicated by an arrow B is rear. The front and rear in this embodiment refer to the front and rear indicated by the arrows in FIG. 3.

In this embodiment, the force to the driving rotation shaft 101 can be applied by artificially pulling up or pushing down the driving rotation shaft 101, or by using the master driving assembly 8 to drive the driving rotation shaft 101 to move upward or downward.

A seat cushion is provided on the upper surface of the seat bracket, and a back cushion 93 is provided on the front side surface of the backrest bracket 3. In this embodiment, the seat cushion and the back cushion 93 are designed separately from the wheelchair bracket and are connected in a manner that is removable for washing, which is convenient to disassemble and replace the seat cushion and the back cushion 93. And when the wheelchair needs to be folded, the seat cushion and the back cushion 93 can be removed to reduce the overall volume of the folded wheelchair. In another embodiment, the seat cushion and the back cushion 93 are designed integrally with the seat bracket, or connected in a manner of non-detachable connection.

In this embodiment, the seat cushion and the back cushion 93 can also be folded together with the wheelchair bracket. In order to facilitate the folding of the wheelchair bracket, the seat cushion includes a front seat cushion 91 and a rear seat cushion 92. The front seat cushion 91 is arranged on the upper end surface of the seat front bracket 1, and the rear seat cushion 92 is arranged on the upper end surface of the seat rear bracket 2. When the seat bracket is folded or unfolded, the front seat cushion 91 is simultaneously unfolded or folded along with the seat front bracket 1, and the rear seat cushion 92 is simultaneously unfolded or folded along with the seat rear bracket 2.

FIG. 3 is a schematic diagram of the structure of a wheelchair bracket according to an embodiment. As shown in FIG. 3, this embodiment uses a schematic diagram of the structure of a wheelchair in the unfolded state to describe the structure of the wheelchair in detail. In this embodiment, the front, back, and up and down are with reference to the direction of the wheelchair in the use state.

As shown in FIG. 3, the wheelchair bracket includes the seat front bracket 1, the seat rear bracket 2, the backrest bracket 3, the rear wheel bracket 5, the front wheel bracket 4 and the armrest bracket 6. The rear end of the seat front bracket 1 and the front end of the seat rear bracket 2 are rotationally connected through the driving rotation shaft 101, and the seat rear bracket 2 is connected with a seat rear driving rotation shaft 102 in the middle part of the backrest bracket 3 through a turning mechanism 64. The rear wheel bracket 5 is arranged by inclining downward from the front end to the rear end, and the front end of the rear wheel bracket 5 is rotationally connected with the seat front bracket 1 through the seat front rotation shaft 104, and the rear end of the rear wheel bracket 5 is rotationally connected with the lower end of the backrest bracket 3 through a rear-wheel rear rotation shaft. And the rear end of the rear wheel bracket 5 is connected with the rear wheel 51. As shown in FIGS. 3 and 19, the upper end of the front wheel bracket 4 is rotationally connected to the front end of the seat front bracket 1 and the front end of the rear wheel bracket 5 through the seat front rotation shaft 104, respectively. The lower end of the front wheel bracket 4 is rotationally connected with the front wheel 41. The rear end of the pedal bracket 7 is rotationally connected to the middle part of the rear wheel bracket 5 through the pedal rear rotation shaft. The middle part of the pedal bracket 7 is rotationally connected to the lower end of the front wheel bracket 4 through the pedal front rotation shaft. The lower end of the pedal bracket 7 is rotationally connected with a foot pedal 71. The anti-roll bracket 20 is arranged by inclining downward from the front end to the rear end, and the front end of the anti-roll bracket 20 is connected with the rear end of the backrest bracket 3. The rear end of the anti-roll bracket 20 is connected with an anti-roll wheel 201, and the anti-roll wheel 201 is in contact with the ground.

In this embodiment, the front wheel bracket 4 is rotationally connected with the rear wheel bracket 5 through the seat front rotation shaft 104, and the front wheel bracket 4 is rotationally connected with the seat front bracket 1 through the seat front rotation shaft 104. In other embodiments, the front wheel bracket 4 can be rotationally connected with the rear wheel bracket 5 through a rotation shaft, and the rear wheel bracket 5 can be rotationally connected to the upper end of the front wheel bracket 4, the seat front bracket 1 or the front end of the seat rear bracket 2 through another rotation shaft.

In an embodiment, the upper end surface of the seat front bracket 1 and the upper end surface of the seat rear bracket 2 are arranged horizontally. The seat front bracket 1 includes a front seat frame and a front seat plate 11 provided on the upper end surface of the front seat frame. The front seat frame includes two first front-seat support rods 12 and a second front-seat support rod. The two first front-seat support rods 12 are respectively arranged on both sides of the seat, and the second front-seat support rod is vertically connected with the two first front-seat support rods 12. The second front-seat support rod is arranged at the front end of the front seat plate 11. The rear end of the first front-seat support rod 12 extends out of the rear end of the front seat plate 11 to connect with the driving rotation shaft 101, and the front end of the first front-seat support rod 12 extends from the front seat plate 11 to connect with the seat front rotation shaft 104. The seat rear bracket 2 includes a rear seat frame and a rear seat plate 21 arranged on the upper end surface of the rear seat frame. The rear seat frame includes first rear-seat support rods 22 and a second rear-seat support rod. The first rear-seat support rods 22 are respectively arranged on both sides of the rear seat plate 21, and the second rear-seat support rod is vertically connected with the first rear-seat support rods 22. The second rear-seat support rod is arranged at the rear end of the rear seat plate 21. The front end of the first rear-seat support rod 22 is fixedly connected with the driving rotation shaft 101, and the first rear-seat support rod 22 is connected with the seat rear rotation shaft 102 through the turning mechanism 64.

In this embodiment, the seat front bracket 1 and the seat rear bracket 2 adopt the structural design of the seat frame and the seat plate, which improves the comfort of the wheelchair user while ensuring the support strength of the seat bracket. At the same time, the seat support rod on both sides of the seat plate can also provide connection support and connection points for the connection to other components. In other embodiments, the seat front bracket 1 and the seat rear bracket 2 may adopt a rod-frame structure as a whole.

In this embodiment, both the front seat plate 11 and the rear seat plate 21 are provided with multiple weight-reducing holes, which can reduce the overall weight of the wheelchair bracket on the one hand, and achieve better ventilation of the seat portion on the other hand. In other embodiments, the front seat plate 11 and the rear seat plate 21 may also be an integrated-plate structure.

In this embodiment, the seat rear bracket 2 is fixedly connected with the driving rotation shaft 101, and the seat front bracket 1 is rotationally connected with the driving rotation shaft 101. In an embodiment, the driving rotation shaft 101 has a circular tubular structure, and the front end of the first rear-seat support rod 22 is welded in connection to the peripheral surface of the driving rotation shaft 101. The rear end of the first front-seat support rod 12 is rotationally connected with the driving rotation shaft 101. In another embodiment, the seat rear bracket 2 is rotationally connected with the driving rotation shaft 101, and the seat front bracket 1 is fixedly connected with the driving rotation shaft 101.

In this embodiment, the length of the front seat plate 11 is shorter than that of the rear seat plate 21, which on the one hand increases the magnitude of turning upward and backward of the rear wheel bracket 5 and the front wheel bracket 4 that are rotationally connected to the seat front bracket 1, so as to increase the folding range of the wheelchair and reduce the overall volume of the wheelchair after multiple components are folded, and on the other hand, reduces the possibility of interference of the front seat bracket 1 with other components during the rotation and folding. In order to improve the support strength of the rear seat plate 21, the rear seat frame further includes a third rear-seat support rod. The third rear-seat support rod is arranged in the middle part of the rear seat plate 21 and is perpendicular to the second rear-seat support rod. In other embodiments, the third rear-seat support rod may also be arranged in parallel or by inclining with the second rear-seat support rod.

When the wheelchair is in the unfolded state, an upward force is applied to the driving rotation shaft 101 to drive the front end of the seat rear bracket 2 to rotate around the seat rear rotation shaft 102. The whole seat front bracket 1 is driven by the driving rotation shaft 101 to rotate backward and upward, and the front end of the seat front bracket 1 is folded downward and backward relative to the rear end of the seat front bracket 1.

In this embodiment, when the wheelchair is in the unfolded state, the seat rear rotation shaft 102 is located above the seat rear bracket 2. When the seat rear bracket 2 rotates around the seat rear rotation shaft 102, the rear end of the rear seat plate 21 is rotated by taking the seat rear rotation shaft 102 as the center and taking the center distance between the seat plate 21 and the seat rear rotation shaft 102 as the radius. On the one hand, the position of the driving rotation shaft 101 is raised during the rotation, which includes the folding range of the rear wheel bracket 5, the front wheel bracket 4 and the pedal bracket 7, and on the other hand, it is more conducive to drive the armrest bracket 6 to perform linkage folding. In other embodiments, the seat rear rotation shaft 102 and the driving rotation shaft 101 may also be located on the same horizontal plane.

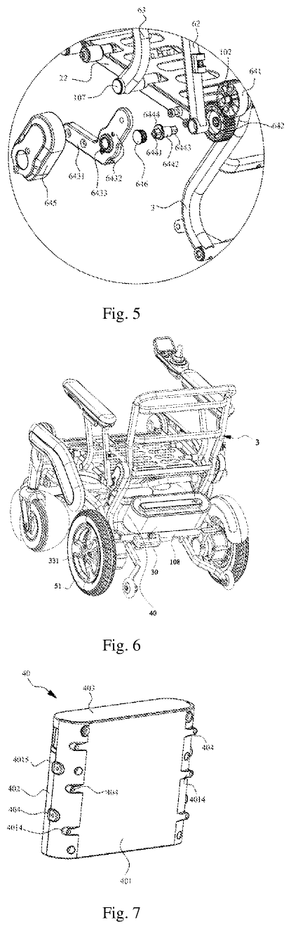

The rear end of the seat rear bracket 2 is connected to the middle part of the backrest bracket 3 through the seat rear rotation shaft 102, and armrest brackets 6 are provided on both sides of the seat rear bracket 2, respectively. FIG. 5 is the split state of the armrest bracket 6 according to this embodiment. As shown in FIGS. 3 and 4, the armrest bracket 6 includes an armrest 61, a first armrest rod 62, and a second armrest rod 63. The armrest 61 is arranged horizontally or by slightly inclining relative to the horizontal direction. The lower end of the first armrest rod 62 is rotationally connected with the seat rear rotation shaft 102 through the turning mechanism 64, and the upper end of the first armrest rod 62 is rotationally connected with the rear end of the armrest 61. The lower end of the second armrest rod 63 is rotationally connected to the middle part of the first rear-seat support rod 22 through the armrest front rotation shaft 107, and the upper end of the second armrest rod 63 is rotationally connected to the front end of the armrest 61.

As shown in FIGS. 4 and 5, the turning mechanism 64 includes a first gear 641, a second gear 642 and an adapter plate 643. The first gear 641 is fixedly sleeved on the seat rear rotation shaft 102, and the first gear 641 is fixedly connected with the backrest bracket 3. The second gear 642 is meshed with the first gear 641, and the second gear 642 is sleeved on the gear rotation shaft 644. The adapter plate 643 includes a first plate 6431 and a second plate 6432 that are connected with each other and have a predetermined angle. The front end of the first plate 6431 is connected with the seat rear bracket 2, and the rear end of the first plate 6431 is connected to the lower end of the second plate 6432. The upper end of the second plate 6432 is rotationally connected with the seat rear rotation shaft 102. The gear rotation shaft 644 is rotationally connected to the lower end of the second plate 6432, and the lower end of the first armrest rod 62 is fixedly connected with the gear rotation shaft 644.

When the front end of the seat rear bracket 2 is folded upward and backward, the rear end of the seat rear bracket 2 is driven to move upward and backward. The rear end of the seat rear bracket 2 is connected with the adapter plate 643, and the adapter plate 643 is rotationally connected with the seat rear rotation shaft 102, and the adapter plate 643 rotates around the rear shaft 102, thereby driving the seat rear bracket 2 to rotate around the seat rear rotation shaft 102. At the same time, the rotation of the adapter plate 643 around the seat rear rotation shaft 102 drives the second gear 642 to revolve around the seat rear rotation shaft 102. Since the first gear 641 is fixed, the meshing of the first gear 641 with the second gear 642 makes the second gear 642 rotate around the central shaft of itself while the second gear 642 revolves around the seat rear shaft 102, so as to drive the gear rotation shaft 644 to rotate. The rotation of the gear rotation shaft 644 drives the first armrest 62 fixedly connected thereto to rotate, so that the first armrest 62 rotates counterclockwise relative to the gear rotation shaft 644.

FIG. 5 is a partial enlarged view of I in FIG. 4. As shown in FIG. 5, the gear rotation shaft 644 includes an armrest connecting portion 6641, a rear-seat connecting portion 6442 and a gear connecting portion 6443 that are connected in sequence. The gear connecting portion 6443 is inserted into a gear center hole. The adapter plate 643 is sleeved on the rear-seat connecting portion 6442, and is rotationally connected with the rear-seat connecting portion 1042. The lower end of the first armrest rod 62 is connected with an armrest connecting sleeve, and the armrest connecting sleeve is arranged with an open connecting groove facing one end of the second gear 642, and the armrest connecting portion 6641 is inserted into the connecting groove.

In this embodiment, the gear connecting portion 6443 is a square protrusion, and the gear center hole is a square hole. The square protrusion is matched and inserted into the square hole to achieve a fixed connection between the second gear 642 and the gear rotation shaft 644, and to prevent circumferential rotation between the second gear 642 and the gear rotation shaft 644. In one embodiment, the gear connecting portion 6443 is a protrusion in the shape of cuboid. The cross section of the armrest connecting portion 6641 is rectangular, and the area of the cross section of the armrest connecting portion 6641 gradually decreases along the direction from the gear connecting portion 6443 to the armrest connecting portion 6641. The shape of the connecting groove is adapted to the shape of the armrest connecting portion 6641, so as to insert the armrest connecting portion 6641 into the connecting groove, which realizes the fixed connection between the first armrest rod 62 and the gear rotation shaft 644, and can prevent the relative rotation between the first armrest rod 62 and the gear rotation shaft 644.

In this embodiment, the structural design of the gear shaft 644 achieves that: the gear rotation shaft 644 fixedly connect with the first armrest rod 62 and the second gear 642, respectively, and there is no relative rotation between any two of the gear rotation shaft 644, the first armrest rod 62 and the second gear 642. In other embodiments, other connection forms can also be used to realize the fixed connection between the gear rotation shaft 644 and the first armrest rod 62, and the fixed connection between the gear rotation shaft 644 and the second gear 642.

The turning mechanism 64 further includes a gear protective box 645. The gear protective box 645 includes a bottom plate and a box cover. The bottom plate is connected with the backrest bracket 3 and is located between the second gear 642 and the backrest bracket 3. The box cover is covered on the outer side of the second plate 6432. The box cover and the bottom plate are connected to form an accommodating cavity. The second plate 6432, the first gear 641 and the second gear 642 are all located in the accommodating cavity to protect the first gear 641 and the second gear 642. The armrest connecting portion 6641 of the gear rotation shaft 644 extends out of the gear protective box 645 to connect with the armrest connecting sleeve. One end of the armrest connecting sleeve is provided with a sealing cover 646, and the sealing cover 646 is configured to seal and protect the gear rotation shaft 644.

An arc-shaped limit flange 6444 is provided between the armrest connecting portion 6641 and the rear-seat connecting portion 6442. A limit block 6433 protrudes on the outer side of the adapter plate 643. When the folding direction is the reference direction, the outer end of the limit flange 6444 abuts against the limit block 6433 to limit the forward folding of the armrest 61 relative to the seat rear bracket 2 when the wheelchair is in the unfolded state.

In this embodiment, the first gear 641 is an incomplete gear. In other embodiments, the first gear 641 may be a sector gear or a complete gear.

In this embodiment, the armrest 61 includes a cover plate and a side wall arranged along the edge of the cover plate. The cover plate is horizontally arranged above the first armrest rod 62 and the second armrest rod 63, and is connected with the side wall by arc transitions, and multiple side walls on the edge of the cover plate are all in connection by arc transitions. The side plate and the cover plate form an accommodation space. The upper ends of the first armrest rod 62 and the second armrest rod 63 are both located in the accommodation space, which enhances the aesthetics of the appearance and increases the comfort of the wheelchair user when using the armrest 61.

As shown in FIG. 4, the backrest bracket 3 has a U-shaped frame structure as a whole, and can be divided into a headrest portion 31, a backrest portion 32, and a support portion 33 that are sequentially connected from top to bottom along the vertical direction. Both the headrest portion 31 and the support portion 33 are arranged by inclining upward from the front end to the rear end, and the backrest portion 32 is arranged vertically or with a slight slope relative to the vertical direction. The arrangement of the headrest portion 31 and the support portion 33 can improve the comfort when the user rests the back on the backrest bracket 3. The lower end of the support portion 33 is provided with an extension portion 34, and the extension portion 34 is formed by the support portion 33 inclining backward and extending downward. The rear end of the extension part 34 is connected to the support shaft 108 arranged horizontally, both ends of the support shaft 108 are respectively connected to the rear wheel 51 in the rear wheel assembly, and the above-mentioned multiple parts of the backrest bracket 3 are connected by smooth arc transitions.

In the design of the support portion 33 and the extension portion 34, by making the lower end of the backrest bracket 3 incline forward, the space can be provided for the installation of batteries, etc., and the overall structure of the wheelchair can be more compact.

FIG. 6 is a schematic diagram of the structure of the wheelchair bracket from another perspective according to an embodiment. In conjunction with FIGS. 4 and 6, a connecting rod 331 is provided in the middle part of the support portion 33 along the horizontal direction, and the front side of the connecting rod 331 is connected with an electrical box. A battery box 30 is provided on the rear side of the connecting rod 331. The side of the battery box 30 facing the connecting rod 331 is provided with two hangers at intervals. The two hangers are hooked on the connecting rod 331, and the battery box 30 is connected with the connecting rod 331 at the two hangers in a detachable manner such as by using threads, which improves the connection stability of the battery box 30 and the backrest bracket 3.

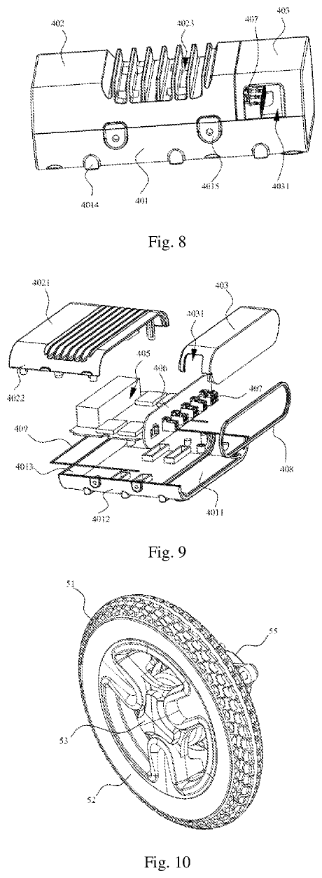

The front side of the backrest bracket 3 is also connected with a control box 40. FIG. 7 is a schematic diagram of the structure of a control box 40 from a perspective according to an embodiment, FIG. 8 is a schematic diagram of the structure of the control box 40 from another perspective according to an embodiment, and FIG. 9 is a schematic diagram of the split structure of the control box 40 according to an embodiment. As shown in FIGS. 7-9, the control box 40 includes a housing and an electronic control assembly 405 arranged in the housing. The housing includes a housing body and a cover body 403 buckled with the housing body. The housing body is provided with a plurality of mounting surfaces, and each mounting surface is provided with a mounting portion 404 configured to be connected with the wheelchair. On the one hand, this kind of arranging method is beneficial for selecting the mounting surface suitable for mounting the control box 40 on the wheelchair according to the structure of the wheelchair and the mounting space of the control box 40, which improves the versatility and mounting convenience of the control box 40. On the other hand, when the mounting portion 404 of one of the mounting surfaces is damaged, the other mounting surfaces can be fixedly mounted with the control box 40 when the space to be mounted allows, thereby reducing the scrap rate of the control box 40.

In this embodiment, the control box 40 is a hexahedron, and is provided with three mounting surfaces, and the three mounting surfaces are located at different positions. In other embodiments, the control box 40 can have other shapes, and the position and number of the mounting surfaces on the control box 40 can be concretely designed according to needs and the shape of the control box 40.

The housing body includes a first housing 401 and a second housing 402 which are arranged relatively. The first housing 401 includes a rectangular first panel 4011, two first side plates 4012 and a first bottom plate 4013. The two first side plates 4012 are respectively arranged on two relative sides of the first panel 4011, the first bottom plate 4013 is arranged on one side of the first panel 4011, and the first bottom plate 4013 is connected to the two first side plates 4012, respectively. The second housing 402 includes a rectangular second panel 4021, two second side plates 4022 arranged on two relative sides of the second panel 4021, and a second bottom plate arranged on one side of the second panel 4021 and connected to the two second side plates 4022. The first panel 4011 and the second plate 4021 are arranged relatively, the first side plate 4012 is clamped with the relative second side plate 4022, the first bottom plate 4013 is clamped with the second bottom plate, so that the first housing 401 and the second housing 402 is buckled and clamped for positioning and connection. At the same time, the first housing 401 and the second housing 402 can also assist the connection by adopting a detachable connection manner such as by using threads to enhance the connection stability of the first housing 401 and the second housing 402.

In this embodiment, the three mounting surfaces on the control box 40 are the surfaces where the first panel 4011 and the two first side plates 4012 are located, so that the control box 40 can be mounted to a wheelchair in a variety of mounting positions. At the same time, all the mounting surfaces are arranged on the first housing 401, which is beneficial to simplify the processing of the housing body. In other embodiments, the three mounting surfaces may be provided on the first panel 4011, the first side plate 4012, and the first bottom panel 4013, respectively. In an embodiment, the three mounting surfaces may be provided on the first housing 401 and the second housing 402, respectively. The number and arrangement position of the mounting surfaces on the control box 40 can be concretely designed as required.

In this embodiment, both the first side plate 4012 and the second side plate 4022 are quarter arc surfaces, one end of the arc surface is tangentially connected with the corresponding panel, and the arc surfaces of the first side plate 4012 and the second side plate 4022 are buckled to form a semi-circular arc surface, which is beneficial to enhance the aesthetics of the control box 40 and prevent the seamed edges on the control box 40 from hurting the wheelchair user. In other embodiments, the arc transition connection may only be adopted between the first side plate 4012 and the first panel 4011, and between the second side plate 4022 and the second panel 4021.

In this embodiment, in order to facilitate the arrangement of the mounting portion 404, the first panel 4011 is provided with a first lug 4014 protruding outward at the junction of the first side plate 4012. The upper surface of the first lug 4014 and the first panel 4014 is flush, and the above-mentioned mounting portion 404 is provided on the upper surface of the first lug 4014. The lower surface of the first lug 4014 is connected to the first side plate 4012. The side of the second side plate 4022 away from the first panel 4011 is provided with a second lug 4015 by protruding outward, the upper surface of the second lug 4015 is perpendicular to the first panel 4011, and the mounting portion 404 is provided on the upper surface of the second lug 4015. The first lugs 4014 are arranged at intervals along the length direction of the first side plate 4012, and there are at least two first lugs 4014. The second lugs 4015 are arranged at intervals along the length direction of the second side plate 4022, and there are at least two second lugs 4015. In this embodiment, two sides of the first panel 4011 are respectively provided with three first lugs 4014, and two second lugs 4015 are provided on each mounting surface. In other embodiments, the positions and number of the first lugs 4014 and the second lugs 4015 can be designed according to needs.

In order to assist the connection and positioning of the first housing 401 and the second housing 402, a positioning lug boss is provided on the inner wall of any one of the first housing 401 and the second housing 402, and a positioning groove is provided on the positioning lug boss. A positioning post is provided on the inner wall of the other one of the first housing 401 and the second housing 402 at a position facing the positioning lug boss, and the positioning post is inserted into the positioning groove to realize the installation and positioning of the first housing 401 and the second housing 402.

The first housing 401 and the second housing 402 are buckled to form an accommodation space with an opening, and the electronic control assembly 405 is located in the accommodation space. The electronic control assembly 405 includes a PCB, and a battery and electronic components arranged on the PCB. A plurality of connecting terminals are provided at one end of the PCB close to the opening. A mounting plate 406 is provided at the position close to the opening in the accommodation space. The positions on the inner wall of the first housing 401 and the inner wall of the second housing 402 close to the openings are correspondingly provided with mounting clamping slots. The mounting clamping slot on the first housing 401 is directly relative to the mounting clamping slot on the second housing 402, and the mounting plate 406 is vertically clamped in the mounting clamping slot. The mounting plate 406 is provided with a plurality of terminal inserting slots along its own length direction, and the shape of the terminal inserting slots is adapted to the shape of the connecting terminals, so that the connecting terminals on the PCB are inserted into the terminal inserting slots. A wiring port 407 is connected to the end of the wiring terminal close to the opening, and the wiring port 407 is configure to connect with an external data line or wire to realize electrical communication inside and outside the electric control box.

When the first housing 401 and the second housing 402 are buckled and connected, the mounting plate 406 is located in the accommodation space, and the wiring port 407 is located at the opening, which facilitates the connection of the wiring port 407 with the external data line. At the same time, the mounting plate 406 is a plate with the same cross-sectional shape as the accommodation space, and a sealing ring 408 is arranged between the mounting plate 406 and the housing body. The mounting plate 406 is clamped in the clamping slot of the sealing ring 408, and the sealing ring 408 is clamped in the mounting clamping slot, so as to facilitate sealing and protecting the PCB and electronic components in the accommodation space. A sealing strip 409 is arranged between the first housing 401 and the second housing 402 to further improve the sealing performance of the accommodation space.

In order to achieve the protecting of the connection port 407, the cover body 403 of the control box 40 is arranged at the opening, and is respectively connected with the first housing 401 and the second housing 402 to form a complete housing structure. In this embodiment, the length of the second housing 402 is shorter than that of the first housing 401. The cover body 403 includes a third panel, third side plates arranged on two relative sides of the third panel, and a third bottom plate arranged on a first end of the third panel. The third bottom plate is respectively arranged relative to the first bottom plate 4013 and the second bottom plate, the side of the third side plate away from the first panel 4011 is connected with the first side plate 4012, and a second end of the third side plate away from the third bottom plate is connected with the second housing 402. In other embodiments, the second housing 402 may be flush with the end of the first housing 401 away from the first bottom plate 4013. The cover body 403 may further include a fourth panel flush with the first panel 4011, and the end of the third side panel away from the third bottom plate is connected to the first housing 401 and the second housing 402, respectively.

By arranging the housing as the first housing 401, the second housing 402 and the cover body 403, on the one hand, the control box 40 can be easily installed and disassembled. On the other hand, by separating or buckling the cover body 403 relative to the housing body, the wiring port 407 can be exposed or covered, facilitating the wiring and maintenance of the wiring port 407. In order to facilitate leading out the wiring of the wiring port 407, the cover body 403 is provided with threading through holes 4031 on the two third side plates, and the external data line can pass through any of the threading through holes 4031 to electrically connect with the electronic control component 405 inside the housing, so as to make the junction of the control box 40 and the external data line more in order, thereby avoiding the confusion caused by that multiple external data lines enter the housing from the multiple threading through holes 4031.

In order to improve the heat dissipation performance of the electronic component, a lug boss is provided at the position on the inner wall of the second housing 402 corresponding to the electronic component. The lug boss abuts against the upper surface of the electronic component. When the electronic component is used, the heat generated by the electronic component is transferred to the lug boss, which is conducive to the diffusion of heat from electronic components. A heat dissipation groove 4023 is provided at a position on the outer wall of the second housing 402 corresponding to the lug boss. The heat dissipation groove 4023 is configured to reduce the wall thickness at the lug boss and improve the heat dissipation efficiency.

Rear wheel assemblies are provided on two ends of the support shaft 108, the rear wheel assembly is provided with rear wheels 51, and the two rear wheel assemblies are respectively provided on both ends of the support shaft 108. FIG. 10 is a schematic diagram of the structure of a rear wheel assembly according to an embodiment, FIG. 11 is a schematic diagram of the structure of the rear wheel assembly of which the cover cap 53 is removed according to an embodiment, and FIG. 12 is an exploded view of FIG. 11. As shown in FIGS. 10-12, the rear wheel assembly includes a wheel hub 52, a rear wheel 51 sleeved around the wheel hub 52, and a rear-wheel driving assembly 55 which is arranged on the first side of the wheel hub 52 and can drive the wheel hub 52 to rotate. The rear wheel assembly further includes a cover cap 53, and the cover cap 53 is arranged on the second side of the wheel hub 52. The first side and the second side of the wheel hub 52 are arranged relatively.

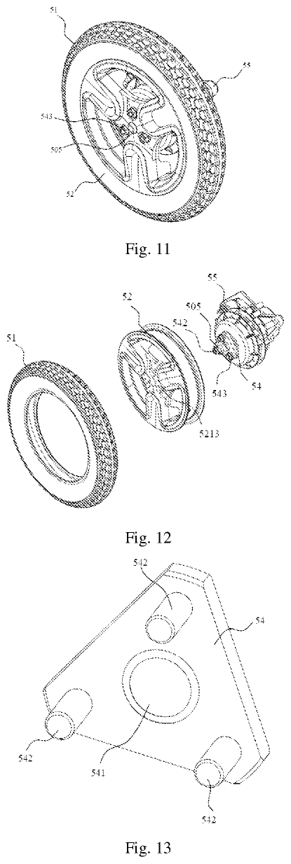

FIG. 13 is a schematic diagram of the structure of a fixing plate 54 and fixing members 542 according to an embodiment. As shown in FIG. 13, the rear wheel assembly further includes a fixing plate 54 and a plurality of fixing members 542. The fixing plate 54 is arranged between the wheel hub 52 and the rear-wheel driving assembly 55. The plurality of fixing members 542 are connected to the side of the fixing plate 54 facing the wheel hub 52. The fixing members 542 pass through the wheel hub 52 and are fastened with locking members 543, so that the fixing plate 54 is connected with the wheel hub 52, thereby achieving the purpose that the driving device drives the wheel hub 52. This structure reduces the fixing difficulty and avoids the risk of easy loosening when using threaded connections. In one embodiment, a fixing hole 541 is provided on the fixing plate 54, and the output shaft 505 of the rear-wheel driving assembly 55 is inserted into and fixed in the fixing hole 541. The fixing plate 54 and the rear-wheel driving assembly 55 are fixedly connected, and the fixing plate 54 can be fixedly connected to the output shaft 505 of the rear-wheel driving assembly 55 by welding or the like. The fixing connection manner between the fixing plate 54 and the output shaft 505 is not limited herein. In this embodiment, the rear-wheel driving assembly 55 is a drive motor.

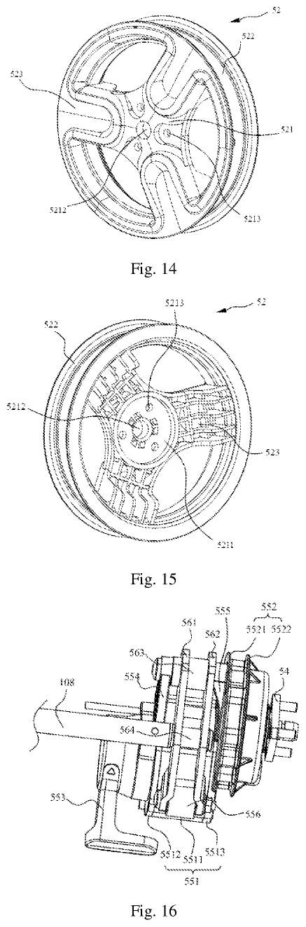

FIG. 14 is a schematic diagram of the structure of a wheel hub 52 viewed from a perspective according to an embodiment, and FIG. 15 is a schematic diagram of the structure of the wheel hub 52 viewed from another perspective according to an embodiment. As shown in FIGS. 14 and 15, the wheel hub 52 includes an inner wheel hub 521, an outer wheel hub 522 and a plurality of spokes 523 connected between the inner wheel hub 521 and the outer wheel hub 522. The rear wheel 51 is sleeved on the periphery of the outer wheel hub 522. A limit groove 5211 is provided on the side of the inner wheel hub 521 of the wheel hub 52 facing the fixing plate 54. The fixing plate 54 can be accommodated in the limit groove 5211, and the limit groove 5211 can play a role of limiting the position of the fixing plate 54. A penetration hole 5212 is provided at the center of the bottom of the limit groove 5211, mounting holes 5213 are provided along the circumferential direction of the penetration hole 5212, and the mounting hole 5213 and the fixing member 542 are arranged in one-to-one correspondence. The output shaft 505 of the rear-wheel driving assembly 55 is inserted into the penetration hole 5212, and the fixing member 542 penetrates out of the limit groove 5211 from the mounting hole 5213. In this embodiment, the fixing member 542 is a screw, and the locking member 543 is a nut. The mounting member of the wheel hub 52 is aligned with the fixing member 542 and then mounted on the fixing member 542. The screw is locked by the nut, so that the wheel hub 52 is fixedly connected to the fixing plate 54, thereby realizing the synchronous rotation of the output shaft 505 and the wheel hub 52.

The cover cap 53 of the rear-wheel assembly is clamped at the junction of the inner wheel hub 521 and the spokes 523. The arrangement of the cover cap 53 can protect the fixing member 542, the output shaft 505 of the rear-wheel driving assembly 55 and the locking member 543 to prevent damage to parts caused by prolonged exposure to wind and sun, and to maintain the aesthetic appearance of the wheelchair.

FIG. 16 is a schematic diagram of the structure of a rear-wheel driving assembly according to an embodiment. The rear-wheel driving assembly 55 includes a driving portion 551, a transmission portion 552, and a braking portion 553. The driving portion 551 mainly includes a drive housing and a driving body provided in the drive housing. The side of the driving portion 551 close to the rear wheel 51 is connected with a transmission portion 552. The transmission part 552 includes a transmission housing and a transmission assembly arranged in the transmission housing. The output shaft 505 of the transmission assembly passes through the transmission housing and penetrates into the fixing hole 541 of the fixing plate 54 to fixedly connect with the fixing plate 54. A brake portion 553 is provided on the side of the driving part 551 away from the rear wheel 51, and a brake is provided on the brake portion 553.

The drive housing includes a driving sleeve 5511 sleeved on the periphery of the driving shaft, and a first sealing cover 5512 and a second sealing cover 5513 that are respectively arranged at both ends of the driving sleeve 5511, wherein both the first sealing cover 5512 and the second sealing cover 5513 are connected with the driving sleeve 5511 in a detachable connection manner such as using bolts. The transmission housing includes a third sealing cover 5521 and a fourth sealing cover 5522. The third sealing cover 5521 and the fourth sealing cover 5522 are arranged relatively to surround a sealed cavity configured to accommodate the transmission assembly. In this embodiment, the third sealing cover 5521 and the second sealing cover 5513 are connected as a whole in an integral forming manner such as welding or casting, so as to improve the connection stability of the driving portion 551 and the transmission portion 552 and to ensure the accuracy of the positional relationship between the driving shaft of the driving portion 551 and the output shaft 505 of the transmission portion 552. In other embodiments, the third sealing cover 5521 may be connected with the second sealing cover 5513 by a means of threaded connection or the like. The fourth sealing cover 5522 is connected with the third sealing cover 5521 in a detachable manner such as threads, which facilitates the installation, disassembly and maintenance of the transmission assembly. The fourth sealing cover 5522 is provided with a through hole for the output shaft 505 to pass through.

In this embodiment, the transmission assembly may be a structure such as gear transmission that capable of realizing power transmission from the driving body to the output shaft 505. In this embodiment, the braking portion 553 is a relatively conventional structure that can realize wheelchair braking, which will not be repeated in this embodiment.

A first connecting ear plate 554 is provided on the first sealing cover 5512, and a second connecting ear plate 555 is provided on the second sealing cover 5513. The first connecting ear plate 554 and the second connecting ear plate 555 are arranged directly relative to each other. The side of the second connecting ear plate 555 close to the rear wheel 51 is integrally connected with the third sealing cover 5521 to enhance the strength of the second connecting ear plate 555. A connecting assembly is provided between the first connecting ear plate 554 and the second connecting ear plate 555, and the connecting assembly is configured to realize the connection of the rear-wheel driving assembly 55 with the support shaft 108 and the rear wheel bracket 5.

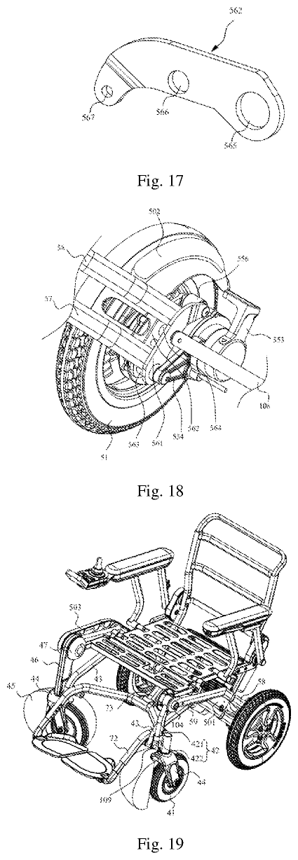

FIG. 17 is a schematic diagram of the structure of a first clamping plate 561 according to an embodiment. As shown in FIGS. 16 and 17, the connecting assembly includes a first clamping plate 561 and a second clamping plate 562. The first clamping plate 561 and the second clamping plate 562 are arranged in parallel at intervals between the first connecting ear plate 554 and the second connecting ear plate 555. A third connecting through hole is provided on the first connecting ear plate 554, and the second connecting ear plate 555 is provided with a first connecting threaded hole at a position corresponding to the third connecting through hole. Both the first end of the first clamping plate 561 and the first end of the second clamping plate 562 are provided with a first connecting through hole 565 corresponding to the third connecting through hole. The connecting assembly further includes a first connecting sleeve 563. The first connecting sleeve 563 includes a sleeve body and a penetrating portion arranged at both ends of the sleeve body. The outer diameter of the penetrating portion is the same as that of the second connecting through hole 567, and smaller than that of the sleeve body. The first end of the sleeve body abuts against the first clamping plate 561, and the second end of the sleeve body abuts against the second clamping plate 562. One side of the first clamping plate 561 abuts against the first connecting ear plate 554, and one side of the second clamping plate 562 abuts against the second connecting ear plate 555. The third connecting through hole of the first connecting ear plate 554, the first connecting through hole of the first clamping plate 561, the first connecting sleeve 563, the first connecting through hole of the second clamping plate 562, and the first connecting threaded hole of the second connecting ear plate 555 are sequentially connected by connecting bolts.

In this embodiment, the second connecting sleeve 564 is connected to one end of the support shaft 108, and the second connecting sleeve 564 is fixedly connected with the first clamping plate 561 and the second clamping plate 562, respectively, so as to realize that the support shaft 108 is fixedly connected with the first clamping plate 561 and the second clamping plate 562, respectively. In other embodiments, one end of the support shaft 108 can also be extended between the first clamping plate 561 and the second clamping plate 562, and be fixedly connected with the first clamping plate 561 and the second clamping plate 562. This embodiment does not make particular restrictions on the manner of fixedly connecting the support shaft 108 with the first clamping plate 561 and the second clamping plate 562.

A third connecting sleeve is provided between the connecting bolt and the first connecting sleeve 563. The inner diameter of the third connecting sleeve is in interference fit with the connecting bolt, and the outer diameter of the third connecting sleeve is in clearance fit with the outer diameter of the first connecting sleeve 563, so that the first connecting sleeve 563 can rotate relative to the connecting bolt.

In order to improve the stability and connection fastening of the connection, the peripheral wall of the driving sleeve 5511 is provided with a connecting lug 556 protruding outwards. The connecting lug 556 is provided on the second end of the first clamping plate 561 and the second end of the second splint 562. And the first end of the connecting lug 556 abuts against the first clamping plate 561, and the second end of the connecting lug 556 abuts against the second clamping plate 562. Second connecting through holes 567 are both at the position of the first clamping plate 561 directly relative to the connecting lug 556 and the position of the second splint 562 relative to the connecting lug 556. A fastening member makes the first clamping plate 561, the connecting lug 556 and the second clamping plate 562 be fixedly connected in sequence through the second connecting through holes 567.

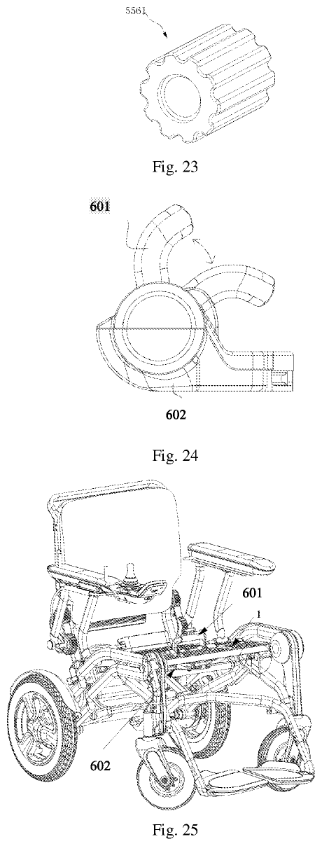

FIG. 23 is a schematic diagram of the structure of a buffer member according to an embodiment. As shown in FIG. 23, a buffer member is provided in the connecting lug 556 to reduce the vibration between the driving portion 551 and the outside. A number of gear-shaped buffer protrusions are provided on the periphery of the buffer member at intervals, and the grooves between the buffer protrusions can provide a buffer space for the buffer member. A support tube made of metal is provided in the buffer member, and the fastening member can penetrate the support tube, and the fastening member is respectively connected with the first clamping plate 561 and the second clamping plate 562, thereby prolonging the service life of the buffer member.

Shaft connecting holes 566 are provided both in the middle part of the first clamping plate 561 and in the middle part of the second clamping plate 562, and the shaft connecting holes 566 are configured to connect with the support shaft 108. FIG. 18 is a schematic diagram of the connection structure of the rear-wheel driving assembly 55 according to an embodiment. As shown in FIG. 18, a second connecting sleeve 564 is fixedly connected to one end of the support shaft 108, and the second connecting sleeve 564 is located between the first clamping plate 561 and the second clamping plate 562, and is fixedly connected with the first clamping plate 561 and the second clamping plate 562, respectively. In order to reduce the vibration between the support shaft 108 and the rear-wheel driving assembly 55, buffer members are provided between the second connecting sleeve 564 and the first clamping plate 561, and between the second connecting sleeve 564 and the second clamping plate 562.

As shown in FIG. 18, the rear wheel bracket 5 includes a first rear-wheel support rod 57 and a second rear-wheel support rod 58 that are arranged in parallel. Both the first rear wheel-support rod 57 and the second rear-wheel support rod 58 are arranged by inclining downward along the front end of the wheelchair to the rear end, and the first rear-wheel support rod 57 is located below the second rear-wheel support rod 58. Both the first rear-wheel support rod 57 and the second rear-wheel support rod 58 have flat steel structures, and both the lower end of the first rear-wheel support rod 57 and the lower end of the lower end of the second rear-wheel support rod 58 are located between the first clamping plate 561 and the second clamping plate 562. The planes on both sides of the first rear-wheel support rod 57 abut against the first clamping plate 561 and the second clamping plate 562, respectively. The planes on both sides of the second rear-wheel support rod 58 abut against the first clamping plate 561 and the second clamping plate 562, respectively. Thus, the first clamping plate 561 and the second clamping plate 562 can support clamping and connecting the lower end of the first rear-wheel support rod 57 and the lower end of the second rear-wheel support rod 58.

The lower end of the first rear-wheel support rod 57 is fixedly connected with the first connecting sleeve 563, and the connection manner may be welding or other connection manner. The lower end of the second rear-wheel support rod 58 is inserted into the gap between the second connecting sleeve 564 and the connecting lug 556. When the rear wheel bracket 5 rotates around the central axis of the first connecting sleeve 563, the lower end of the second rear-wheel support rod 58 can move in the gap between the second connecting sleeve 564 and the connecting lug 556.

In order to strengthen the connection strength of the first clamping plate 561 and the second clamping plate 562 and ensure the relative positional relationship between the first clamping plate 561 and the second clamping plate 562, the first clamping plate 561 and the second clamping plate 562 can also be connected integrally through a connecting post, wherein the connecting post is arranged between the second connecting sleeve 564 and the first connecting sleeve 563 to avoid interference with the movement of the second rear-wheel support rod 58.

As shown in FIG. 18, a rear wheel baffle 502 is provided on the front side of the rear wheel 51. The rear wheel baffle 502 is provided on the inner side of the rear wheel 51. The rear wheel baffle 502 is configured to prevent mud formed during the operation of the rear wheel 51 from sputtering on the wheelchair user. In this embodiment, the rear wheel baffle 502 is fixed on the first rear-wheel support rod 57 and the second rear-wheel support rod 58. In other embodiments, the rear wheel baffle 502 may also be fixed on the second clamping plate 562.

FIG. 19 is a schematic diagram of the partial structure of the wheelchair bracket according to an embodiment. As shown in FIG. 19, the rear wheel bracket 5 further includes a third rear-wheel support rod 59 that is horizontally arranged. The front end of the third rear-wheel support rod 59 is rotationally connected to the front end of the first rear-seat support rod 22. The middle part of the third rear-wheel support rod 59 is fixedly connected to the upper end of the first rear-wheel support rod 57. The rear end of the third rear-wheel support rod 59 is fixedly connected to the upper end of the second rear-wheel support rod 58. In order to improve the support strength of the rear wheel bracket 5, and stiffener plates 501 are further provided on the rear wheel bracket 5. Stiffener plates 501 are respectively arranged at the junctions of the first rear-wheel support rod 57, the second rear-wheel support rod 58 and the third rear-wheel support rod 59, and are respectively connected with the first rear-wheel support rod 57, the second rear-wheel support rod 58 and the third rear-wheel support rod 59.

The first rear-wheel support rod 57, the second rear-wheel support rod 58 and the third rear-wheel support rod 59 are located in the same plane. The rear wheel bracket 5 further includes a bracket protection plate 503. The bracket protection plate 503 is arranged on the outer side of the first rear-wheel support rod 57, the outer side of the second rear-wheel support rod 58 and the outer side of the third rear-wheel support rod 59, and the bracket protection plate 503 has a flanging that is bent inward to shield and protect the aforementioned support rods of the rear wheel 51, and at the same time, the flanging on the bracket protection plate 503 adopts a smooth arc design to prevent the seamed edges of the rear wheel bracket 5 from hurting the wheelchair user.

The front wheel bracket 4 includes a first front-wheel support rod 42, a second front-wheel support rod 43, and a front-wheel connecting frame 44. The first front-wheel support rod 42 is vertically arranged, and the second front-wheel bracket 4 is arranged by inclining upward along the front end of the wheelchair to the rear end. The upper end of the front-wheel support rod 42 is rotationally connected with the front end of the seat front bracket 1 through the seat front rotation shaft 104. The lower end of the first front-wheel support rod 42 is rotationally connected with the lower end of the second front-wheel support rod 43 through the front-wheel lower rotation shaft 109. The upper end of the second front-wheel support rod 43 is rotationally connected to the front end of the seat rear bracket 2. The upper end of the front-wheel connecting frame 44 is rotationally connected to the lower end of the first front-wheel support rod 42. The lower end of the front wheel connecting frame 44 is rotationally connected with the front wheel 41.

The second front-wheel support rod 43 includes a first section, a second section and a third section that are connected in sequence. The upper end of the first section is connected with the seat rear bracket 2. The lower end of the third section is hinged with the front-wheel support rod 42. The first section, the second section and the third section are all arranged by inclining upward from the front end of the seat rear bracket 2 to the rear end of the seat rear bracket 2, and both the inclination slope of the first section and the inclination slope of the third section are greater than that of the second section. In addition, the first section is connected with the second section by adopting a first transition arc, and the second section is connected with the third section by adopting the second transition arc.

The above-mentioned structural design of the second front-wheel support rod 43 enables to form a front avoidance space at the junction of the first section and the second section, thereby avoiding the interference with the second front wheel bracket 4 in the downward movement of the seat rear bracket 2 during the folding process. At the same time, a rear avoidance space is formed at the junction of the second section and the third section to avoid the interference between the second rear-wheel support rod 58 and the pedal bracket 7 during the folding process of the seat rear bracket 2. At the same time, the structural design of the second front-wheel support rod 43 is more conducive to both the connection between the upper end of the second front-wheel support rod 43 and the seat rear bracket 2, and the connection between the lower end of the second front-wheel support rod 43 and the first front-wheel support rod 42 in a vertical connection way, which is conducive to the connection and installation of the wheelchair and the aesthetics of the appearance.

The first front-wheel support rod 42 includes a connecting rod portion 421 and a hinging portion 422. The upper end of the connecting rod portion 421 is rotationally connected with the seat front bracket 1. The lower end of the connecting rod portion 421 is connected with the hinging portion 422. The hinging portion 422 includes a first hinging portion and a second hinging portion that are adjacently arranged. The connecting rod portion 421 has a tubular structure, the first hinging portion is a sleeve tube, the lower end of the first front-wheel support rod 42 is inserted into the sleeve tube, and the front-wheel lower rotation shaft 109 is rotationally arranged at the lower end of the first hinging portion and vertically connected with the sleeve tube. The second hinging portion is a sleeve, and the front wheel 41 is rotationally connected to the lower end of the second hinging portion. In one embodiment, a rotation shaft of the front wheel is provided on the upper end of the front-wheel connecting frame 44. The rotation shaft of the front wheel extends into the second hinging portion and is rotationally connected with the hinging portion, and a bearing is arranged between the rotation shaft of the front wheel and the sleeve. The inner diameter of the bearing is in interference fit with the rotation shaft of the front wheel, and the outer diameter of the bearing is in clearance fit with the inner diameter of the sleeve.

The front wheel connecting frame 44 has an inclined U-shaped structure. The beam portion of the U-shaped structure is provided with the above-mentioned rotation shaft of the front wheel 41. The front wheel 41 is arranged in the U-shaped groove of the U-shaped structure. Both ends of the U-shaped structure are rotationally connected with the central rotation shaft of the front wheel 41. The front wheel bracket 4 further includes a front wheel stopper 45. The front wheel stopper 45 is arranged on the inner side of the front wheel 41 and is fixedly connected with a connecting member on the front wheel 41. The front wheel stopper 45 is configured to prevent flying mud caused by the front wheel 41 from sputtering on the wheelchair user, and at the same time, to prevent the trouser legs or clothing of the wheelchair user from getting involved in the front wheel 41 and causing danger to the wheelchair user, thereby improving the safety protection for the wheelchair user. The surface of the front wheel stopper 45 facing the wheelchair user is a circular arc surface, which prevents the feet of the wheelchair user from contacting the front wheel stopper 45 and causing bumps to the wheelchair user.

The front wheel bracket 4 further includes a protection box 46. The protection box 46 is rotationally sleeved on the seat front rotation shaft 104. The protection box 46 includes a first half box and a second half box that are arranged relatively. The connection of the first half box and the second half box forms an accommodating cavity. The first front-wheel support rod 42 is located in the accommodating cavity. The bottom surface of the protection box 46 abuts against the lower end of the first hinging portion to play a role of supporting the hinging portion 422. A hole for the second hinging portion to extend out or a hole for the rotation shaft of the front wheel 41 to extend in is opened on the bottom surface of the protection box 46. The surface of the protection box 46 facing the inner side of the wheelchair is provided with a gap corresponding to the first hinging portion, so as to facilitate the connection of the first hinging portion and the front-wheel lower rotation shaft 109.

The front wheel bracket 4 further includes a protection cover 47. The protection cover 47 is connected to the inner end of the seat front rotation shaft 104. The protection cover 47 has a bowl-shaped structure and an opening of the bowl-shaped structure faces the protection box 46. The front end of the first front-seat support rod 12 extends into the protection cover 47 to connect with the seat front rotation shaft 104.

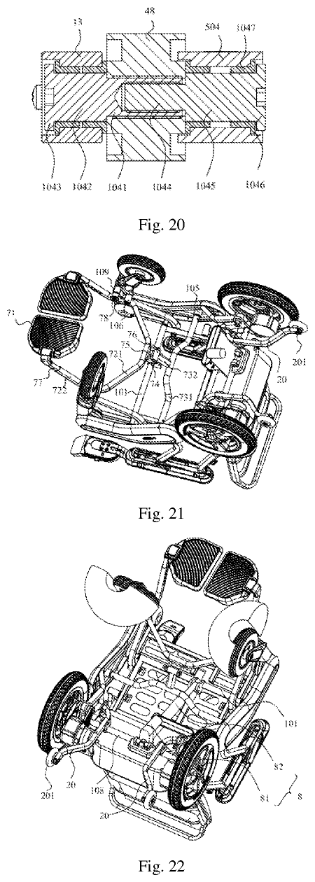

FIG. 20 is a schematic diagram of the structure of a seat front rotation shaft according to an embodiment. As shown in FIG. 20, the seat front rotation shaft 104 includes a first shaft and a second shaft that are designed separately. The first shaft includes a front-wheel connecting portion 1041, a seat connecting portion 1042, and a first limiting portion 1043 whose outer diameters increase in sequence. The second shaft includes a shaft connecting portion 1044, a rear-wheel connecting portion 1045, and a second limiting portion 1046 whose outer diameters increase in sequence. The front-wheel connecting portion 1041 is provided with internal threads on the end surface, the shaft connecting portion 1044 is provided with external threads, and the front wheel connecting portion 1041 and the shaft connecting portion 1044 are connected by threads.

A front-wheel connecting sleeve 48 is provided on the upper end of the first front-wheel support rod 42, and the front-wheel connecting sleeve 48 is sleeved on the front-wheel connecting portion 1041. A seat connecting sleeve 13 is provided on the front end of the first front-seat support rod 12, and the seat connecting sleeve 13 is sleeved on the seat connecting portion 1042. A rear-wheel connecting sleeve 504 is provided on the front end of the third rear-wheel support rod 59, and the rear wheel connecting sleeve 504 is sleeved on the rear-wheel connecting portion 1045. In this embodiment, the front-wheel connecting sleeve 48 and the front-wheel connecting portion 1041 are fixedly connected by threads, the seat connecting sleeve 13 and the seat connecting portion 1042 are rotationally connected, and the rear-wheel connecting sleeve 504 rotationally and the rear-wheel connecting portion 1045 are rotationally connected, thereby realizing the rotation of the front wheel bracket 4 relative to the seat front bracket 1 and the rotation of the rear wheel bracket 5 relative to the front wheel bracket 4.

In order to limit the front-wheel connecting sleeve 48, the rear-wheel connecting sleeve 504, and the seat connecting sleeve 13 to moving on the shaft of the seat front rotating shaft 104, a plurality of limit sleeves 1047 are provided on the seat front rotating shaft 104. In an embodiment, the limit sleeves 1047 are provided between the front-wheel connecting sleeve 48 and the seat connecting sleeve 13, between the seat connecting sleeve 13 and the first limiting portion 1043, between the front-wheel connecting sleeve 48 and the rear-wheel connecting sleeve 504, and between the rear-wheel connecting sleeve 504 and the second limiting portion 1046.

FIG. 21 is a schematic diagram of the structure of a pedal bracket 7 according to an embodiment. As shown in FIGS. 19 and 21, the pedal bracket 7 includes a pedal front bracket 72 and a pedal rear bracket 73. The middle part of the pedal front bracket 72 is connected to the lower end of the front wheel bracket 4 through the pedal front rotation shaft 106. The rear end of the pedal front bracket 72 is rotationally connected to the front end of the pedal rear bracket 73. The front end of the pedal rear bracket 73 is rotationally connected to the middle part of the rear wheel bracket 5 through the pedal rear rotation shaft 105.

In an embodiment, the pedal rear bracket 73 includes a first rear support rod 731 and a second rear support rod 732. The first rear support rod 731 extends along the width direction of the seat bracket, and both ends of the first rear support rod 731 are rotationally connected to the middle part of the rear wheel bracket 5, respectively. The middle of the first rear support rod 731 is bent toward the pedal front bracket 72. The rear end of the second rear support rod 732 is vertically connected to the middle part of the first rear support rod 731, and the second rear support rod 732 is arranged by inclining downward from the rear end of the pedal rear support 73 to the front wheel 41. The front end of the second rear support rod 732 is rotationally connected to the rear end of the pedal front bracket 72.

The pedal front bracket 72 includes a first front support rod 721 and a second front support rod 722. The first front support rod 721 has a U-like structure, and the opening width of the U-like structure reduces gradually from the front end of the first front support rod 721 to the rear end of the first front support rod 721. The middle part of the U-like structure is rotationally connected to the pedal rear bracket 73. Both ends of the first front support rod 721 are respectively rotationally connected to the lower ends of both sides of the front wheel bracket 4. Both ends of the first front support rod 721 are respectively inclined forward and extended downward. A foot pedal 71 is connected to the front end of the second front support rod 722.

The pedal front bracket 72 and the pedal rear bracket 73 are rotationally connected by a hinging assembly. The hinging assembly includes a hinging shaft 74, a hinging frame 75 and a hinging sleeve 76. The first end of the hinging frame 75 is fixedly connected to the middle part of the pedal front frame 72, and the second end of the hinging frame 75 is fixedly connected with the hinging shaft 74. The hinging sleeve 76 is rotationally sleeved on the hinging shaft 74. The peripheral surface of the hinging sleeve 76 is connected with the lower end of the second rear support rod 732.

The hinging assembly further includes a limit sleeve. The limit sleeve includes a sleeve portion and a limit portion. The inner diameter of the sleeve portion is matched with the outer diameter of the hinging shaft 74, and the outer diameter of the sleeve portion is matched with the inner diameter of the hinging sleeve 76. The limit portion is arranged at one end of the sleeve portion, and the outer diameter is larger than the outer diameter of the sleeve portion. The first side of the limit portion abuts against the limit sleeve, and the second side of the limit portion abuts against the hinging frame 75. The above-mentioned limit sleeves are provided on both ends of the hinging sleeve 76.

The junction of the first front support rod 721 and the junction of the second front support rod 722 adopts arc transitions. The front-wheel lower rotation shaft 109 is located at the junction of the upper arc transition of the second front support rod 7221. An end of the front-wheel lower rotation shaft 109 close to the pedal bracket 7 is connected with a support sleeve 78. The support sleeve 78 is provided with a V-shaped groove along the circumferential direction. The pedal front bracket 72 is located above the support sleeve 78 and is overlapped in the V-shaped groove.

An adjusting rod 77 is connected to the front end of the second front support rod 722. The adjusting rod 77 penetrates into the second front support rod 722. The adjusting rod 77 is provided with an adjusting threaded hole. The second front support rod 722 is provided with adjusting through holes. A plurality of the adjusting through holes are arranged along the length direction of the adjusting rod 77 at intervals. The arrangement of the adjusting rod 77 can adjust the height of the pedal relative to the ground, so that the pedal can be adjusted adaptively according to the personal situation of the wheelchair user, thereby situating the pedal at the most suitable pedal position for the wheelchair user.

The foldable seat further includes an anti-roll wheel frame 20. The front end of the anti-roll wheel frame 20 is connected with the support shaft 108. The rear end of the anti-roll wheel frame 20 is connected with an anti-roll wheel 201. Two anti-roll wheel frames 20 are arranged at intervals along the length direction of the support shaft 108, which is beneficial to improve the support stability of the anti-roll wheel frame 201 to the wheelchair. During the folding process of the wheelchair, the anti-roll frame 20 and the backrest bracket 3 do not fold, so as to provide support for the folding of the wheelchair. After the wheelchair is folded, both the anti-roll wheel 201 and the rear wheel 51 are in contact with the ground, and the anti-roll wheel 201, the rear wheel 51 and the support shaft 108 form a triangular support, which improves the support for the folded the seat of the rear wheel 51, so that the folded wheelchair maintains an upright posture, which is beneficial for transporting or moving the folded wheelchair.

FIG. 22 is a schematic diagram of the structure of a master driving assembly 8 located on the wheelchair according to an embodiment. As shown in FIG. 22, the master driving assembly 8 provided in this embodiment includes a fixing portion 81 and a telescopic portion 82. The rear end of the fixing portion 81 is arranged on the support shaft 108, and rotationally connected with the support shaft 108. The front end of the fixing portion 81 is connected to the rear end of the telescopic portion 82. The front end of the telescopic portion 82 is connected with the driving rotation shaft 101, and the telescopic portion 82 can be extended or contracted relative to the fixing portion 81, thereby driving the driving rotation shaft 101 to fold or unfold the wheelchair. The seat front bracket 1 is provided with an avoidance opening corresponding to the junction of the telescopic portion 82 to prevent interference with the telescopic portion 82 during the folding process of the seat front bracket 1. In this embodiment, the master driving assembly 8 is a driving piston cylinder. The piston cylinder seat of the driving piston cylinder is rotationally connected with the support shaft 108, and a piston rod is connected with the driving rotation shaft 101.

As shown in FIGS. 24-25, the wheelchair of this embodiment further includes a locking mechanism provided on the seat front bracket 1. The locking mechanism includes a switch member 601 and a locking execution member 602, wherein the switch member 601 has a locking position and an unlocking position. When the switch member 601 is switched to the locking position, the lock execution member 602 locks the bracket on the pedal side, and at this time, the entire wheelchair frame is locked and cannot be folded or unfolded. When the switch 601 is switched to the unlocking position, the locking execution member 602 unlocks the bracket on the pedal side, and at this time, the wheelchair can be folded by pulling the handle of the switch 601 with one hand.

In one embodiment, the switch member 601 also has a neutral position. The neutral position has a section of neutral travel. The switch member 601 can move freely along the neutral travel on the neutral position. When the switch member 601 is switched to the neutral position, the locking execution member 602 locks the bracket on the pedal side, and at this time, the entire wheelchair frame is locked and cannot be folded or unfolded. The purpose of setting the neutral position is that when the wheelchair is folded, the wheelchair can be transported or dragged by the handle. Since the neutral position has a section of neutral travel, during the swing of the handle, the locking execution member 602 will not be triggered to unlock the bracket on the pedal side, which improves the convenience of transporting or dragging the wheelchair.

1. A wheelchair, comprising: an armrest bracket, a seat bracket, a backrest bracket, and a turning mechanism, wherein the turning mechanism is configured to make the armrest bracket and the seat bracket rotate synchronously relative to the backrest bracket.

2. The wheelchair according to claim 1, wherein the armrest bracket includes an armrest, and a first armrest rod and a second armrest rod that are arranged on the armrest at intervals, both a first end of the first armrest rod and a first end of the second armrest rod are rotationally connected with the armrest, a second end of the first armrest rod is connected with the backrest bracket through the turning mechanism and can rotate relative to the backrest bracket, and a second end of the second armrest rod is rotationally connected to the rear end of the seat bracket.

3. The wheelchair according to claim 2, wherein the turning mechanism includes an adapter plate, a gear rotation shaft, and a first gear and a second gear that are meshed with each other, a first end of the adapter plate is fixedly connected with the seat bracket, and a second end of the adapter plate is rotationally connected with the backrest bracket; and
the first gear is fixedly connected with the backrest bracket, the second gear is rotationally connected to the middle part of the adapter plate through the gear rotation shaft, and the end of the first armrest rod away from the armrest is fixedly connected with the gear rotation shaft.

4. The wheelchair according to claim 3, wherein the adapter plate includes a first plate and a second plate that are connected with each other and have a predetermined angle, a first end of the first plate is fixedly connected with the seat bracket, a second end of the first plate is fixedly connected to a first end of the second plate, a second end of the second plate is rotationally connected with the backrest bracket, and the gear shaft is rotationally connected with the first end of the second plate.

5. The wheelchair according to claim 3, wherein the first gear is an incomplete gear.

6. The wheelchair according to claim 3, wherein the gear rotation shaft includes a gear connecting portion, a rear seat connecting portion and an armrest connecting portion that are sequentially connected along the axial direction of the gear rotation shaft, the gear connecting portion is inserted into a central hole of the second gear; the armrest connecting portion is inserted with the end of the first armrest rod away from the armrest, and the adapter plate is rotationally sleeved on the rear-seat connecting portion.

7. The wheelchair according to claim 6, wherein the gear connecting portion is a protrusion in the shape of cuboid, the central hole is a square hole, and the four peripheral surfaces of the protrusion are respectively fit with four inner sidewalls of the square hole.

8. The wheelchair according to claim 6, wherein the cross section of the armrest connecting portion is rectangular, the area of the cross section gradually decreases along the direction from the gear connecting portion to the armrest connecting portion, the first armrest rod is provided with a connecting groove, and the connecting groove is inserted with the armrest connecting portion.

9. The wheelchair according to claim 6, wherein the gear rotation shaft further includes a limit flange, the limit flange is arranged between the rear seat connecting portion and the armrest connecting portion, a limit block is provided on the side of the adapter plate away from the gear shaft, and the limit flange is configured to abut against the limit block to limit the downward turning of the seat bracket relative to the backrest frame in an unfolded state.

10. The wheelchair according to claim 2, wherein the armrest includes a cover plate and a side plate arranged along the edge of the cover plate, the cover plate and the side plate enclose an accommodation space, and both the upper end of the first armrest rod and the upper end of the second armrest rod are located in the accommodation space.
